(19) United States
(12) Patent Application Publication
(10) Pub. No.: US 2009/0180207 A1
(43) Pub. Date: Jul. 16, 2009

(54) HARD DISK DRIVE AND METHOD OF CONTROLLING AUTO REASSIGN OF THE SAME

(75) Inventor: Hyung Joon CHO, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/353,425

(22) Filed: Jan. 14, 2009

(30) Foreign Application Priority Data
Jan. 15, 2008 (KR) 2008-4626

(51) Int. Cl. G11B 27/36; G11B 21/02

(52) U.S. Cl. 360/31; 360/77.02

(57) ABSTRACT

A method of controlling auto reassign of a hard disk drive, including measuring a position error signal (PES) value from at least one sample track of a disk when a fault is generated in a recording and reproduction process of the hard disk drive, comparing the measured PES value and a process PES value of the at least one sample track, and determining whether the hard disk drive is abnormally operated under a particular condition in which a normal operation is not achieved and whether the execution of auto reassign is to be performed.

### CROSS-REFERENCE TO RELATED APPLICATIONS

This application claims priority under 35 U.S.C. §119 to Korean Patent Application No. 10-2008-0004626, filed on 15 Jan. 2008, in the Korean Intellectual Property Office, the disclosure of which is incorporated herein by reference in its entirety.

### BACKGROUND OF THE INVENTION

1. Field of the Invention

The present general inventive concept relates to a hard disk drive (HDD) and a method of controlling auto reassign of the HDD, and more particularly, to an HDD and a method of controlling auto reassign of the HDD which can improve stability in a data recording and reproduction process of a read/write head with respect to a disk, and prevent unnecessary auto reassign of the HDD.

2. Description of the Related Art

Hard disk drives (HDDs) are devices to record data on a disk or reproduce data stored on the disk by using a read/write head. The HDDs are widely used as auxiliary memory devices of computer systems because of their fast access time to a large amount of data.

With the recent increase in TPI (tracks per inch) and BPI (bits per inch), the HDD has achieved a high capacity and its application field has expanded. Accordingly, there has been a request for development of compact HDDs which can be used for portable electronic products such as laptops, personal digital assistants (PDAs), and mobile phones. In addition to conventional 2.5″ HDDs, a compact HDD having a diameter of 0.85 inches, whose size is similar to a coin, has been actively developed and is expected to be used for mobile phones or MP3 players.

In a typical configuration of an HDD, the HDD includes a disk pack having a plurality of disks rotatably supported on a shaft, a head stack assembly in which a read/write head for performing a data recording and reproduction process with respect to the disk is installed at a tip end of the head stack assembly, a voice coil motor for driving the head stack assembly, a printed circuit board assembly, a base, and a cover.

In the above configuration, when power is supplied, the head stack assembly pivots around a predetermined pivot shaft so that the read/write head installed at the tip end of the head stack assembly can be positioned at a desired target position on the disk. Simultaneously, as the disk rotates, the read/write head can be maintained at an appropriate flying height.

When a drive operation is performed in a normal environment, the recording and reproduction process of the read/write head with respect to the disk may be reliably performed. However, when particular conditions such as temperature, pressure, and humidity reach an extreme environment beyond a preset range of a reference temperature, a reference humidity, and a reference pressure, the HDD may not be physically operated any longer.

FIG. 1A is a graph illustrating a position error signal (PES) when the HDD is operated in an extreme environment. FIG. 1B is a graph illustrating a position error signal when the HDD is operated in a normal environment. As illustrated in FIGS. 1A and 1B, the position error signal is substantially changed when the HDD is in an extreme environment compared to a normal environment. That is, when the HDD is operated in the extreme environment of temperature, pressure, and humidity, an abrupt change occurs in the frequency of the position error signal, which is outside a preset range. If the data recording and reproduction process of the read/write head with respect to the disk continues in such a situation, an adjacent track may be erased or damaged. Also, when the recording and reproduction process of the read/write head with respect to the disk is not properly performed, unnecessary auto reassign may be generated.

In order to protect user data, the auto reassign process assigns a track where errors are generated to a spare area so that a defect track where data cannot be recorded or reproduced, generated after a manufacturing process, cannot be accessed. The auto reassign is generally performed for all cases where fault is generated during the recording and reproduction process of the read/write head.

However, in the extreme environment in which a normal operation of the HDD is not achieved, the auto reassign is performed whenever fault is generated during the recording and reproduction process of the read/write head. As a result, access speed or data processing speed may be deteriorated, and the performance of the HDD may be decreased.

Thus, if the auto reassign can be performed only when an actual defect is generated in a track, and not when fault is generated during the recording and reproduction process of the read/write head in the extreme environment where the normal operation of the HDD is not achieved, unnecessary auto reassign can be prevented from being performed so that the access speed or data processing speed can be improved. Also, the development of an HDD capable of stably managing data is needed.

### SUMMARY OF THE INVENTION

The present general inventive concept can provide an HDD and a method of controlling auto reassign of the HDD to prevent unnecessary auto reassign from being performed so that the performance of the HDD such as access speed or data processing speed can be improved and stability of a data recording and reproduction process of the read/write head can be improved.

Additional aspects and/or utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of controlling auto reassign of a hard disk drive, including measuring a position error signal (PES) value from at least one sample track of a disk when a fault is generated in a recording and reproduction process of the hard disk drive, comparing the measured PES value to a process PES value of the at least one sample track, and determining whether the hard disk drive is abnormally operated under a particular condition in which a normal operation is not achieved and whether the execution of auto reassign is to be performed.

The comparing of the measured PES value and the process PES value can include obtaining an absolute value of a value obtained by subtracting the process PES value from the measured PES value, and comparing the absolute value to a preset threshold to determine whether the hard disk drive is abnormally operated under a particular condition in which a normal operation is not achieved and whether the execution of auto reassign is to be performed.

When the absolute value is greater than the preset threshold, the hard disk drive can be determined to be abnormally operated so that the non-execution of auto reassign is determined.

The method may further include warning a user of information about the abnormal operation of the hard disk drive when the non-execution of auto reassign is determined.

When the absolute value is less than the preset threshold, an additional defect can be determined to exist in the sample track and the execution of auto reassign is determined.

The particular condition in which a normal operation is not achieved can be at least one of temperature, pressure, and humidity out of a range of a preset reference temperature, a preset reference pressure, and a preset reference humidity, respectively.

The foregoing and/or other aspects and utilities of the present general inventive concept may also be achieved by providing a hard disk drive including a read/write head to record data on a disk or to reproduce data recorded on the disk, and a controller to measure a position error signal (PES) value from at least one sample track of the disk when a fault is generated in a recording and reproduction process of the hard disk drive, to compare the measured PES value to a process PES value of the at least one sample track, and to determine whether the hard disk drive is abnormally operated under a particular condition in which a normal operation is not achieved and whether the execution of auto reassign is to be performed.

The controller can obtain an absolute value of a value obtained by subtracting the process PES value from the measured PES value, can compare the absolute value and a preset threshold, and can determine whether the hard disk drive is abnormally operated under a particular condition in which a normal operation is not achieved and whether the execution of auto reassign is to be performed.

When the absolute value is greater than the preset threshold, the controller can determine that the hard disk drive is abnormally operated so that the non-execution of auto reassign is determined.

The controller can warn a user of information about the abnormal operation of the hard disk drive when the non-execution of auto reassign is determined.

When the absolute value is less than the preset threshold, the controller can determine that an additional defect exists in the sample track so that the execution of auto reassign is determined.

The particular condition in which a normal operation is not achieved can be at least one of temperature, pressure, and humidity out of a range of a preset reference temperature, a preset reference pressure, and a preset reference humidity, respectively.

The foregoing and/or other aspects and utilities of the present general inventive concept may also be achieved by providing a method of controlling an auto reassign operation of a hard disk drive, including detecting a fault in a read or write operation of the hard disk drive, measuring a position error signal (PES) value from at least one sample track when the fault is detected, and comparing the measured PES value to a reference PES value to determine whether execution of the auto reassign operation is to be performed.

The determining operation may include comparing a difference between the measured PES value and the reference PES value to a predetermined threshold value, and determining whether execution of the auto reassign operation is to be performed based on the comparison to the predetermined threshold value.

When it is determined that the auto reassign operation is not to be performed, the method may further include determining whether an additional fault exists in the at least one sample track, and performing the auto reassign operation when it is determined that the additional fault exists.

The method may further include generating a warning signal to a user indicating non-execution of the auto reassign operation when it is determined that the auto reassign operation is not to be performed.

The reference PES value can be obtained during a process of manufacturing the disk and/or during a process of operating the hard disk drive in a controlled environment.

The foregoing and/or other aspects and utilities of the present general inventive concept may also be achieved by providing a hard disk drive, including a read/write head to read data from the disk or to write data to the disk, and a controller to detect a fault in the read or write operations of the disk, to measure a position error signal (PES) value from at least one sample track when the fault is detected, to compare the measured PES value to a reference PES value, and to determine whether execution of an auto reassign operation of the hard disk drive is to be performed based on the comparison.

The controller may compare a difference between the measured PES value and the reference PES value to a predetermined threshold value, and may determine whether execution of the auto reassign operation is to be performed based on the comparison to the predetermined threshold value.

When the controller determines that the auto reassign operation is not to be performed, the controller can determine whether an additional fault exists in the at least one sample track, and if so, can perform the auto reassign operation based on the additional fault.

The foregoing and/or other aspects and utilities of the present general inventive concept may also be achieved by providing an electronic device, including a processing unit to process data, and a hard disk drive (HDD) connected to the processing unit to read and/or write the data, the HDD including a read/write head to read data from the disk or to write data to the disk, and a controller to detect a fault in the read or write operations of the disk, to measure a position error signal (PES) value from at least one sample track when the fault is detected, to compare the measured PES value to a reference PES value, and to determine whether execution of an auto reassign operation of the hard disk drive is to be performed based on the comparison.

### BRIEF DESCRIPTION OF THE DRAWINGS

The above and/or other aspects and utilities of the present general inventive concept will become apparent and more readily appreciated from the following detailed description, taken in conjunction with the accompanying drawings of which:

FIG. 1A is a graph illustrating a position error signal when the HDD is operated in an extreme environment;

FIG. 1B is a graph illustrating a position error signal when the HDD is operated in a normal environment;

FIG. 2 is an exploded perspective view of an HDD according to an embodiment of the present general inventive concept;

FIG. 3 is a plan view of the HDD of FIG. 2;

FIG. 4 illustrates the configuration of the disk of FIG. 3;

FIG. 5 is a block diagram of an HDD drive circuit employing a method of controlling auto reassign of an HDD according to an embodiment of the present general inventive concept;

FIG. 6 is a flowchart illustrating the method of controlling auto reassign of an HDD according to an embodiment of the present general inventive concept; and

FIG. 7 is a block diagram illustrating an electronic device using an HDD according to an embodiment of the present general inventive concept.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

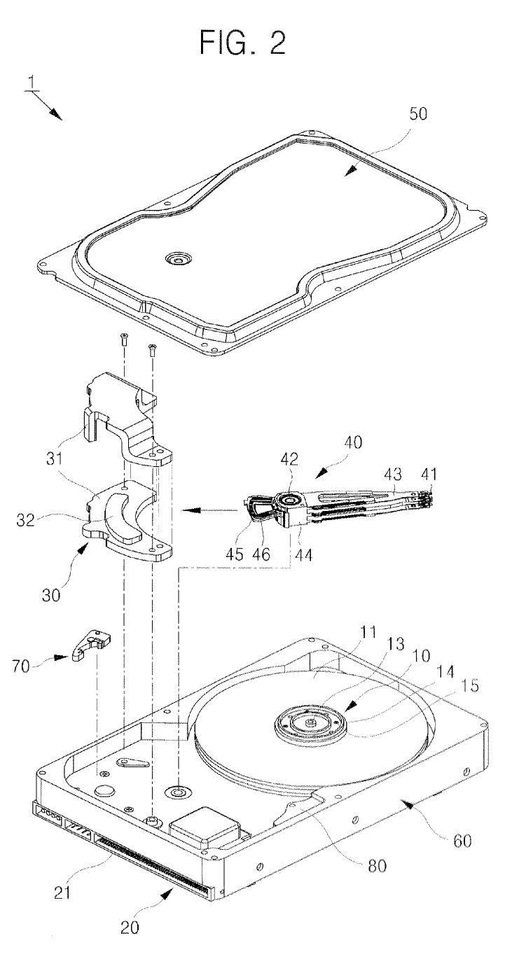

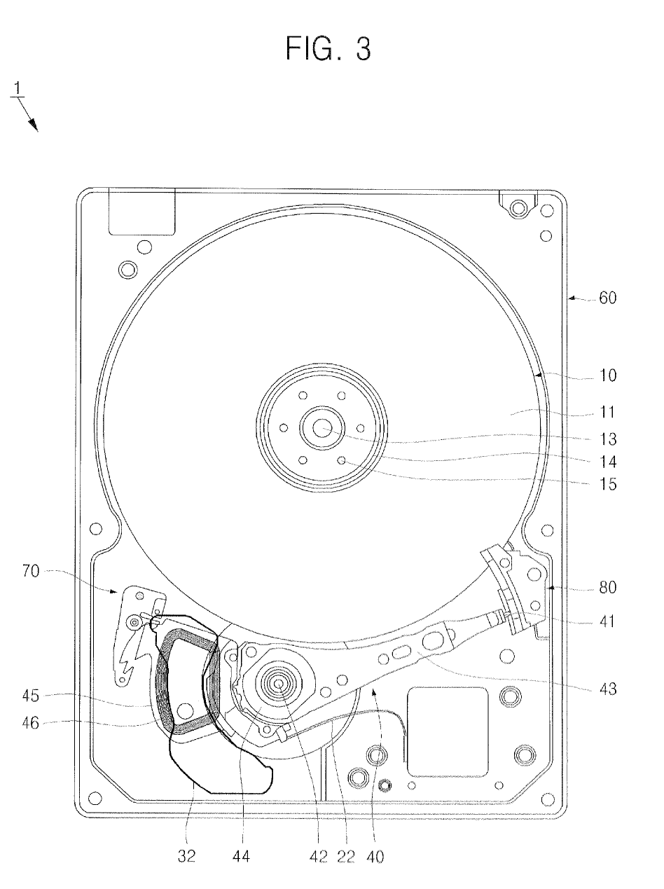

FIG. 2 is an exploded perspective view of an HDD 1 according to an embodiment of the present general inventive concept. FIG. 3 is a plan view of the HDD of FIG. 2. Referring to FIGS. 2 and 3, the HDD 1 according to the present embodiment can include a disk pack 10 having at least one disk 11 to record and reproduce data, a printed circuit board assembly (PCBA) 20, a head stack assembly (HSA) 40 having a read/write head 41 installed at a tip end thereof to write data to the disk 11 and/or to read data from the disk 11, a voice coil motor (VCM) 30 to pivot the HSA 40, a base 60 to which the foregoing elements can be installed, and a cover 50 to enclose the elements installed to the base.

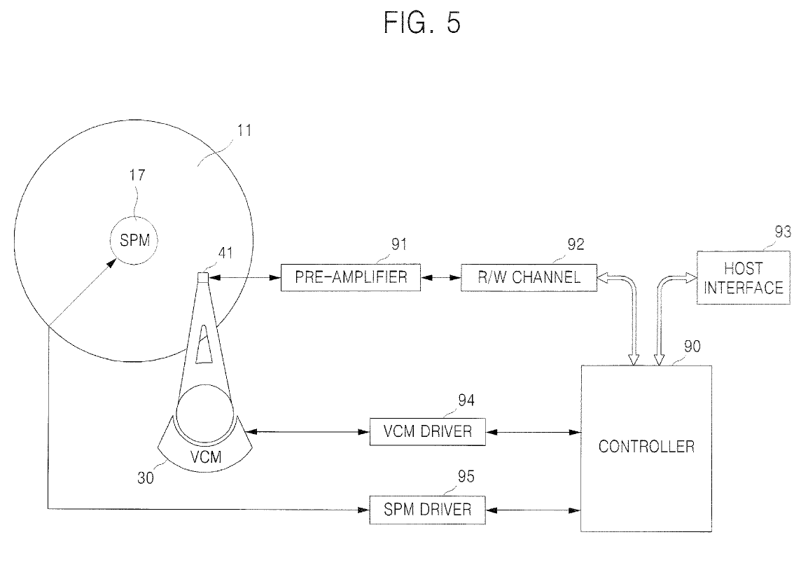

The disk pack 10 can include a disk 11, a shaft 13 to form a central axis of rotation of the disk 11, a spindle motor hub (not illustrated) can be provided radially outside the shaft 13 and supporting the disk 11, a spindle motor (SPM) 17 (FIG. 5) coupled to an upper portion of the spindle motor hub to rotate the spindle motor hub, a clamp 14 coupled to the upper portion of the spindle motor hub, and a clamp screw 15 to press the clamp 14 to fix the disk 11 to the spindle motor hub.

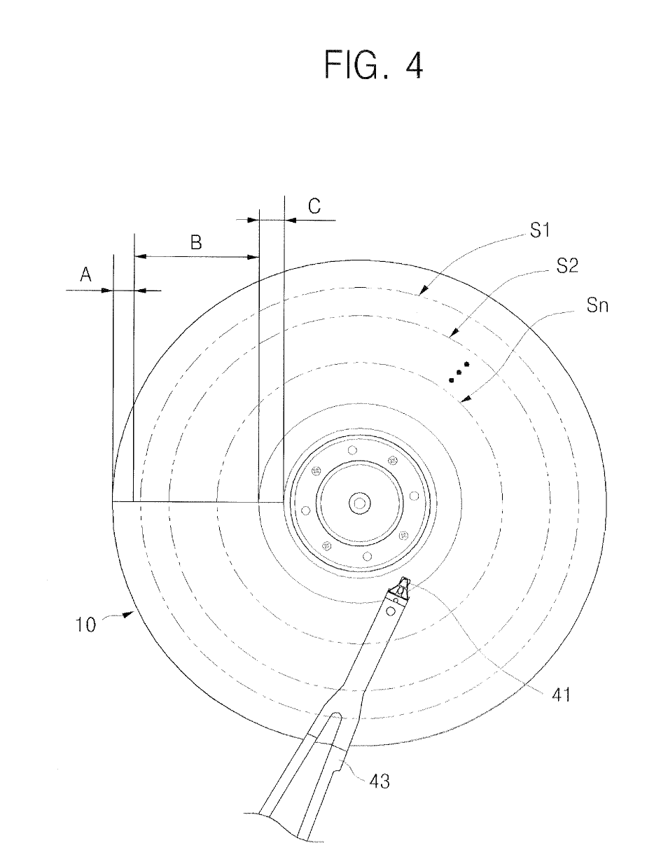

As illustrated in FIG. 4, the disk 11 may be divided into a system zone A, a user data zone B, and a parking zone C. The system zone A may be referred to as a maintenance zone where various system information and information about maintenance and repair of the HDD 1 can be stored. The parking zone C can be an area to park the read/write head 41 on the disk 11. A method of parking the read/write head 41 when the supply of power to the HDD 1 is stopped will be referred to as a contact start stop (CSS) method. As illustrated in FIGS. 2 and 3, when a ramp 80 is provided on the base 60 adjacent to the outer circumference of the disk 11, the read/write head 41 can be parked on the ramp 80. In this case, the parking zone C can be excluded from the disk 11. Also, a bobbin 45 of the HSA 40 can be coupled to a latch portion 70, for example, with a hook.

The user data zone B which can exist between the system zone A, and the parking zone C can be used as an area to store user data. The user data zone B can occupy most of the surface of the disk 11. Data can be recorded on one of tracks that are concentrically formed on the surface of the disk 11. The track of the disk 11 can be sectioned into a plurality of blocks referred to as sectors for the data recording and reproduction process. As described above, during the operation of an HDD, when a fault is generated during the recording and reproduction process using the read/write head 41, a defect track where the fault is generated can be reassigned to a spare area through an auto reassign operation.

Referring to FIGS. 2 and 3, the PCBA 20 can include a printed circuit board (not illustrated) having a plate shape and coupled to a rear surface of the base 60 via a PCB connector 21. A flexible printed circuit board (FPCB) 22 can be installed on an upper surface of the base 60 adjacent to the HSA 40 to electrically connect the HSA 40 and the PCB. A plurality of chips (not illustrated) and circuits (not illustrated) to control the disk pack 10, the HSA 40 and the VCM 30 can be provided on the PCB to exchange signals with external devices via the PCB connector 21

Referring to FIG. 2, the VCM 30 can serve as a drive motor to pivot the HSA 40 in a direction to move the read/write head 41 to a desired position on the disk 11. The VCM 30 can include a VCM block 31 having a pair of magnets 32 and a voice coil 46 installed on the bobbin 45. The VCM 30 can use the Fleming's left hand rule, that is, when current flows in a conductive body existing in a magnetic field, an electromagnetic force can be generated to move the HSA 40. Accordingly, as current is supplied to the voice coil 46 existing between the magnets 32, a force can be applied to the bobbin 45 so that the bobbin 45 pivots. Thus, since the HSA 40 pivots in a predetermined direction, the read/write head 41 can be installed at an end portion of the actuator arm 43 to search the tracks and access data, moving in a radial direction of the rotating disk 11. As a result, data can be recorded on the disk 11 or reproduced from the disk 11.

The HSA 40 can serve as a carrier to record data on the disk 11 or to reproduce the data from the disk 11, including the read/write head 41 to write data to the disk 11 or to read the recorded data, the actuator arm 43 to pivot across the disk 11 around the pivot shaft 42. The pivot shaft 42 can serve as a shaft center about which the actuator arm 43 can pivot to allow the read/write head 41 to pivot across the disk and to access the data on the disk 11. A pivot shaft holder 44 coupled to the actuator arm 43 can be provided to rotatably support the pivot shaft 42, and the bobbin 45 can be integrally formed with the actuator arm 43 at the opposite side of the actuator arm 43 with respect to the pivot shaft holder 44.

The read/write head 41 can read or write information with respect to the rotatable disk 11 by detecting a magnetic field formed on the surface of the disk 11. For data recording and reproduction, the read/write head 41 can include a read head to detect the magnetic field of the disk 11 and a write head to magnetize the disk 11.

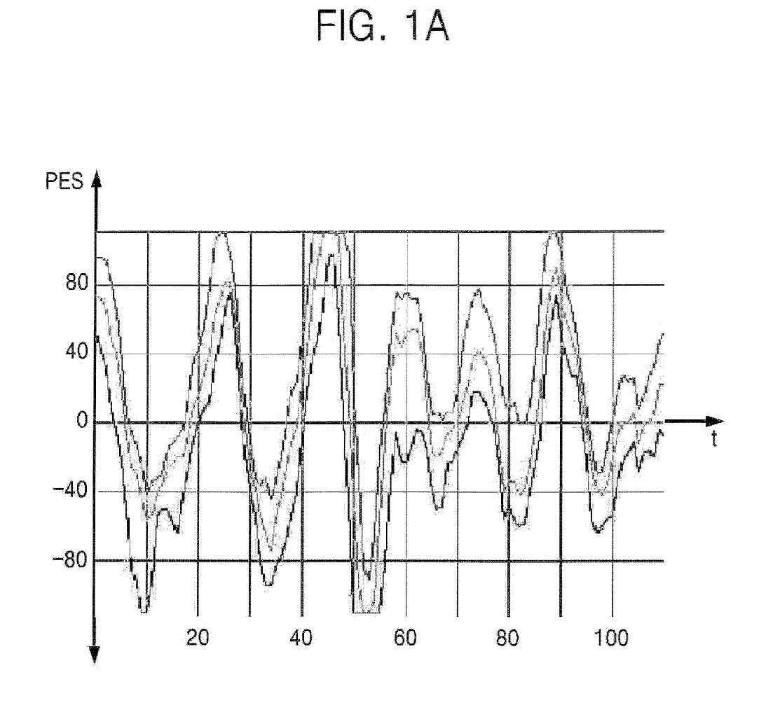

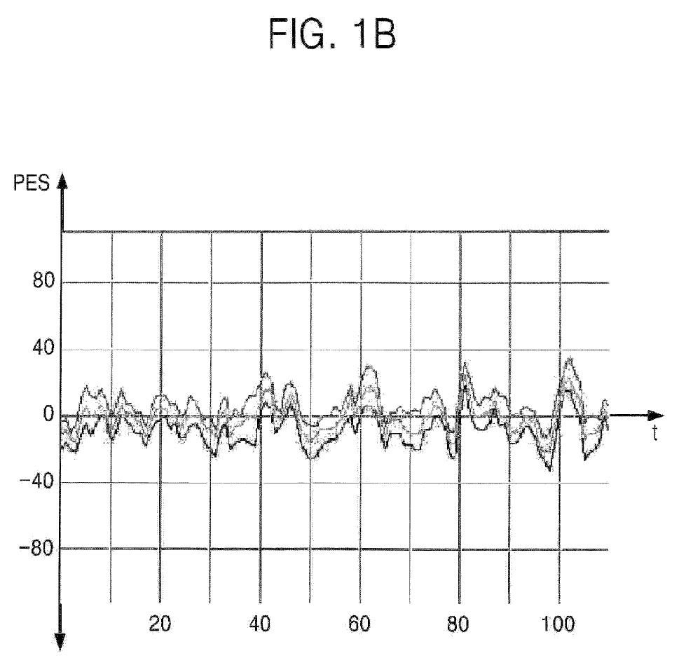

When the HDD 1 is operated in an environment in which conditions such as temperature, pressure, and humidity are extremely different from those of a normal environment, a physically abnormal (i.e. diminished) operation may be generated as described above. That is, as illustrated in FIG. 1A, when the HDD 1 is operated in an extreme environment, an abrupt change can occur in the frequency of a position error signal (PES). In such an abnormal environment, the HDD 1 may operate out of a preset range for the PES so that adjacent tracks may be erased or damaged when the read/write head 41 continues the data recording and reproduction process with respect to the disk 11. Accordingly, when the data recording and reproduction process of the read/write head 41 with respect to the disk 11 is not properly performed, the auto reassign job may be unnecessarily generated.

To overcome this limitation, the HDD 1 according to the present general inventive concept can include a controller 90 (FIG. 5) to determine whether the auto reassign operation is performed or not, according to a preset standard.

For example, FIG. 5 is a block diagram of an HDD drive circuit employing a method of controlling auto reassign of an HDD according to an embodiment of the present general inventive concept. Referring to FIG. 5, a controller 90 can include a pre-amplifier (pre-AMP) 91, a read/write (R/W) channel 92, a host interface 93, a VCM driver 94, and a spindle motor (SPM) driver 95.

The pre-amplifier 91 can amplify a data signal that the read/write head 41 reproduces from the disk 11. The pre-amplifier can amplify a write current converted by the read/write (R/W) channel 92, and can record the amplified write signal on the disk 11 using the read/write head 41. The R/W channel 92 can convert the signal amplified by the pre-amplifier 91 to a digital signal and can transmit a converted signal to a host device (not illustrated) via a host interface 93. The R/W channel 92 can receive data input by a user via the host interface 93, can convert a received data to a binary data stream to facilitate recording, and can input a converted data to the pre-amplifier 91.

Similar to a CPU or I/O controller of a computer system, the host device can be used to collectively signify elements that generally control and operate a whole computer system including the HDD 1. The VCM driver 94 can control the amount of current supplied to the VCM 30 in response to a control signal of the controller 90. The SPM driver 95 can control the amount of current supplied to the SPM 17 in response to the control signal of the controller 90.

The controller 90 can receive the data via the host interface 93 that the user inputs through the host device in a data write mode and can output a received data to the R/W channel 92. In a data reproduction mode, the controller 90 can receive a read signal converted to a digital signal by the R/W channel 92 and can output a received signal to the host interface 93. Also, the controller 90 can control the outputs of the VCM driver 94 and the SPM driver 95. The controller 90 may be a microprocessor, a microcontroller, or any suitable device chosen with sound engineering judgment to perform the method of controlling auto reassign of the HDD 1. The controller 90 may be embodied in the form software or firmware to perform the methods of the present general inventive concept.

When a fault is generated in the recording and reproduction process of the read/write head 41 with respect to the disk 11 during the operation of the HDD 1, the controller 90 can measure a PES value from at least one of preset sample tracks S1, S2, . . . , Sn on the disk 11, can compare a measured PES value with a process PES value of the sample tracks S1, S2, . . . , Sn and can determine whether the HDD is operating abnormally in a particular condition in which a normal operation is not achieved, and can determine whether the execution of auto reassign should be performed. Thus, compared to the conventional technology, access speed or data processing speed can be improved, and data can be stably managed. The process PES value, which may also be referred to as a reference PES value, can be obtained during a process of manufacturing the hard disk, but is not limited thereto. For example, the process PES value could also be obtained by inspecting or operating the hard disk in a controlled, environmentally neutral environment, to establish a reference PES value of the disk.

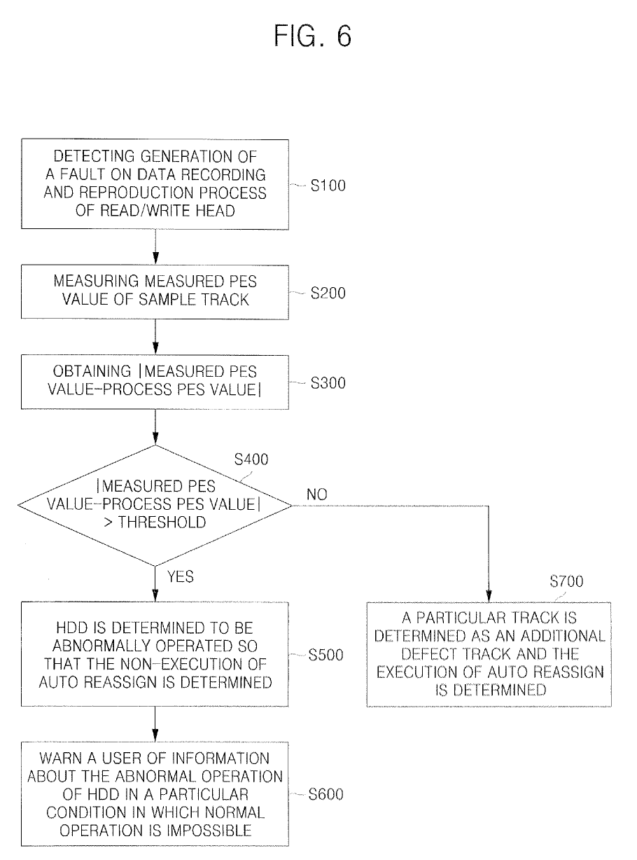

A method of controlling auto reassign of an HDD according to an embodiment of the present general inventive concept will be described with reference to FIG. 6. FIG. 6 is a flowchart illustrating the method of controlling auto reassign of an HDD according to an embodiment of the present general inventive concept.

As described above, during the operation of the HDD 1, when the internal environment of the HDD 1 is in an extreme environment, a physically abnormal phenomenon may be generated. That is, when the conditions such as temperature, pressure, and humidity are extremely increased or decreased compared to those in the normal environment, the read/write head 41 is not able to precisely access a target position on the disk 11 and may access an adjacent track to erase or damage the track. Accordingly, when the data recording and reproduction process of the read/write head 41 is not properly performed with respect to the disk 11, auto reassign may be unnecessarily generated.

As illustrated in FIG. 6, a method of controlling auto reassign of an HDD according to an embodiment of the present general inventive concept can include detecting a fault generated in a recording and reproduction process of the read/write head 41 with respect to the disk 11 (operation S100), measuring a measured PES value from at least one of preset sample tracks S1, S2, . . . , Sn on the disk 11 (operation S200), comparing the measured PES value and a process PES value of the at least one of the sample tracks S1, S2, . . . , Sn relative to a threshold value (operations S300, S400), and determining whether the HDD 1 is operated in a particular condition in which a normal operation is not achieved and whether the execution of auto reassign should be performed (operations S500, S700). A warning signal can be provided to the user containing information about non-execution of auto reassign when the auto reassign is determined not to be performed (operation S600). The process PES value can be measured during a process of manufacturing the hard disk, although the present general inventive concept is not limited thereto.

In the measurement operation S200, when a fault is generated in the recording and reproduction process of the read/write head 41 during the operation of the HDD in an actual environment, the controller 90 can measure a PES, that is, a measured PES value, from the sample tracks S1, S2, . . . , Sn formed on the disk 11, as illustrated in FIG. 6.

Conventionally, when a fault is generated in the recording and reproduction process of the read/write head with respect to the disk, a track where the fault is generated or a sector of the track is automatically reassigned to a spare area. This is done to improve reliability of data by reassigning the section of a track where a fault is generated. However, if the auto reassign is performed whenever a fault is generated under an extreme environment including temperature, pressure, and humidity in which a normal operation of the HDD 1 is not achieved, access speed and data processing speed can be substantially deteriorated.

Thus, the method of controlling auto reassign of an HDD according to an embodiment of the present general inventive concept can include the determination operations S300, S400, S500, and S700 in which the execution of auto reassign can be determined based on a preset threshold value to avoid unnecessary auto reassign operations under extreme environment conditions including temperature, pressure, and humidity in which the normal operation of the HDD 1 is not achieved.

In the determination operations S300, S400, S500, and S700, the determination of whether to perform auto reassign can be made by comparing the measured PES value actually measured from the sample tracks S1, S2, . . . , Sn during the operation of the HDD 1 to the process PES value measured from the sample tracks S1, S2, . . . , Sn during the process of manufacturing the hard disk drive.

For example, the determination operations S300, S400, S500, and S700 can obtain an absolute PES value by subtracting the process PES value from the measured PES value (operation S300), comparing the absolute PES value to the preset threshold (operation S400), and determining whether the execution of auto reassign is needed based on the comparison (operations S500 and S700). The measured PES value and the process PES value can be measured from the same sample tracks S1, S2, . . . , Sn, where the measured PES value is measured in an actual environment and the process PES value is measured in a process environment.

Accordingly, in the determination operations S300, S400, S500, and S700, the execution of auto reassign can be determined by comparing an absolute PES value and a preset threshold. For example, when the absolute value is greater than the preset threshold, the non-execution of the auto reassign can be determined (operation S500). When the absolute value is smaller than the threshold, the execution of the auto reassign can be determined (operation S700).

When the non-execution of auto reassign is determined (operation S500), the controller 90 can determine that the HDD 1 is operating abnormally and can control the HDD 1 to not perform auto reassign. The user can then be warned about the abnormal operation of the HDD 1 under a particular condition in which the normal operation is not achieved, and the user can prepare for the abnormal operation of the HDD based on the warning information.

In the determination operation S700 in which the execution of auto reassign is determined when the absolute value is smaller than the threshold, an additional defect can be determined to exist in the sample tracks S1, S2, . . . , Sn where the measured PES value is measured so that the execution of auto reassign is determined.

According to embodiments of the present general inventive concept, since the execution of unnecessary auto reassign operations can be prevented, performance such as access speed and/or data process speed can be improved, and stability in the data recording and reproduction process of the read/write head can be improved.

In particular, whether the execution of auto reassign should be performed can be determined by comparing the absolute value of a difference between the measured PES value and the process PES value and the threshold. However, the present general inventive concept is not limited thereto, and the execution of auto reassign can be determined by comparing the measured value obtained through other types of disk operations and preset thresholds.

Furthermore, according to embodiments of the present general inventive concept, unnecessary auto reassign can be prevented from being performed so that the performance of the HDD such as access speed or data processing speed can be improved, and improved stability of a data recording and reproduction process of the read/write head can be achieved.

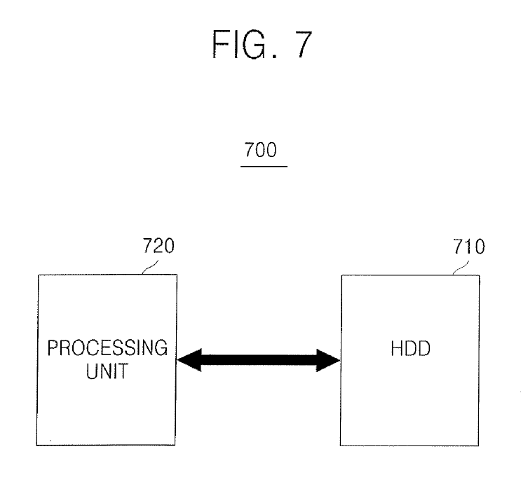

FIG. 7 illustrates an electronic device 700 in accordance with an embodiment of the present general inventive concept. The electronic device 700 may be a computer system or other processor-based electronic products such as laptops, personal digital assistants (PDAs), mobile phones, or other known or later developed computer systems and/or electronic devices having an HDD or other memory device to read and/or write data therein. As illustrated in FIG. 7, the electronic device 700 can include a processing unit 720 to communicate with the HDD 710 to transmit and receive data, to process the data, and to read and/or write the data. The methods and apparatuses illustrated in FIGS. 1-6 can be used in the electronic device 700 of FIG. 7. The HDD 710 can include a read/write head to read data from the disk or to write data to the disk, and a controller to detect a fault in the read or write operations of the disk, to measure a position error signal (PES) value from at least one sample track when the fault is detected, to compare the measured PES value to a reference PES value, and to determine whether execution of an auto reassign operation of the hard disk drive is to be performed based on the comparison.

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A method of controlling auto reassign of a hard disk drive, the method comprising:
measuring a position error signal (PES) value from at least one sample track of a disk when a fault is generated in a recording and reproduction process of the hard disk drive; and
comparing the measured PES value to a process PES value of the at least one sample track, and determining whether the hard disk drive is abnormally operated under a particular condition in which a normal operation is not achieved and whether the execution of auto reassign is to be performed.

2. The method of claim 1, wherein the comparing of the measured PES value and the process PES value comprises:
obtaining an absolute value of a value obtained by subtracting the process PES value from the measured PES value; and
comparing the absolute value to a preset threshold to determine whether the hard disk drive is abnormally operated under a particular condition in which a normal operation is not achieved and whether the execution of auto reassign is to be performed.

3. The method of claim 2, wherein when the absolute value is greater than the preset threshold, the hard disk drive is determined to be abnormally operated so that the non-execution of auto reassign is determined.

4. The method of claim 3, further comprising:
warning a user of information about the abnormal operation of the hard disk drive when the non-execution of auto reassign is determined.

5. The method of claim 2, wherein when the absolute value is less than the preset threshold, an additional defect is determined to exist in the sample track and the execution of auto reassign is determined.

6. The method of claim 1, wherein the particular condition in which a normal operation is not achieved is at least one of temperature, pressure, and humidity out of a range of a preset reference temperature, a preset reference pressure, and a preset reference humidity, respectively.

7. A hard disk drive comprising:
a read/write head to record data on a disk or to reproduce data recorded on the disk; and
a controller to measure a position error signal (PES) value from at least one sample track of the disk when a fault is generated in a recording and reproduction process of the hard disk drive, to compare the measured PES value to a process PES value of the at least one sample track, and to determine whether the hard disk drive is abnormally operated under a particular condition in which a normal operation is not achieved and whether the execution of auto reassign is to be performed.

8. The hard disk drive of claim 7, wherein the controller obtains an absolute value of a value obtained by subtracting the process PES value from the measured PES value, compares the absolute value to a preset threshold, and determines whether the hard disk drive is abnormally operated under a particular condition in which a normal operation is not achieved and whether the execution of auto reassign is to be performed.

9. The hard disk drive of claim 8, wherein, when the absolute value is greater than the preset threshold, the controller determines that the hard disk drive is abnormally operated so that the non-execution of auto reassign is determined.

10. The hard disk drive of claim 9, wherein the controller warns a user of information about the abnormal operation of the hard disk drive when the non-execution of auto reassign is determined.

11. The hard disk drive of claim 9, wherein, when the absolute value is less than the preset threshold, the controller determines that an additional defect exists in the sample track so that the execution of auto reassign is determined.

12. The hard disk drive of claim 7, wherein the particular condition in which a normal operation is not achieved is at least one of temperature, pressure, and humidity out of a range of a preset reference temperature, a preset reference pressure, and a preset reference humidity, respectively.

13. A method of controlling an auto reassign operation of a hard disk drive, the method comprising:
detecting a fault in a read or write operation of the hard disk drive;
measuring a position error signal (PES) value from at least one sample track when the fault is detected; and
comparing the measured PES value to a reference PES value to determine whether execution of the auto reassign operation is to be performed.

14. The method of claim 13, wherein the determining operation comprises:
comparing a difference between the measured PES value and the reference PES value to a predetermined threshold value; and
determining whether execution of the auto reassign operation is to be performed based on the comparison to the predetermined threshold value.

15. The method of claim 14, wherein when the difference between the measured PES value and the reference PES value is less than the predetermined threshold value, determining that an additional fault exists in the at least one sample track and performing the auto reassign operation.

16. The method of claim 13, further comprising:
generating a warning signal to a user indicating non-execution of the auto reassign operation when it is determined that the auto reassign operation is not to be performed.

17. The method of claim 13, wherein the reference PES value is obtained during a process of manufacturing the disk and/or during a process of operating the hard disk drive in a controlled environment.

18. A hard disk drive, comprising:
a read/write head to read data from the disk or to write data to the disk; and
a controller to detect a fault in the read or write operations of the disk, to measure a position error signal (PES) value from at least one sample track when the fault is detected, to compare the measured PES value to a reference PES value, and to determine whether execution of an auto reassign operation of the hard disk drive is to be performed based on the comparison.

19. The hard disk drive of claim 18, wherein the controller compares a difference between the measured PES value and the reference PES value to a predetermined threshold value, and determines whether execution of the auto reassign operation is to be performed based on the comparison to the predetermined threshold value.

20. The hard disk drive of claim 19, wherein when the difference between the measured PES value and the reference PES value is less than the predetermined threshold value, the controller determines that an additional fault exists in the at least one sample track and performs the auto reassign operation.

21. An electronic device, comprising:
a processing unit to process data; and
a hard disk drive (HDD) connected to the processing unit to read and/or write the data, the HDD comprising:
a read/write head to read data from the disk or to write data to the disk; and
a controller to detect a fault in the read or write operations of the disk, to measure a position error signal (PES) value from at least one sample track when the fault is detected, to compare the measured PES value to a reference PES value, and to determine whether execution of an auto reassign operation of the hard disk drive is to be performed based on the comparison.
